(19) United States
(12) Patent Application Publication
(10) Pub. No.: US 2004/0101598 A1
(43) Pub. Date: May 27, 2004

(54) Dessert cone with embedded strip

(76) Inventor: Pamela Paulhus, Somers, NY (US)

Correspondence Address: Karl F. Milde, Jr., Esq., MILDE & HOFFBERG, L.L.P., Suite 460, 10 Bank Street, White Plains, NY, 10606, US

(21) Appl. No.: 10/307,378

(22) Filed: Nov. 26, 2002

(51) Int. Cl. A23L 1/00

(52) U.S. Cl. 426/87

(57) ABSTRACT

An edible food serving receptacle, such as an ice cream cone, with an embedded, but removable, strip, such as a paper strip, bearing an indicia such as a message about e.g. good fortune or wisdom, nutritional or education information, especially nutritional education, a sales discount coupon, a collectible item, an edible sample or medication, or a game or puzzle piece; the strip may have a partial adhesive coating covered by a releasable cover strip.

### BACKGROUND OF THE INVENTION

The present invention relates to ice cream cones, and similar edible wafer, or confection, receptacles for serving frozen desserts and the like. The present invention also relates to fortune cookies containing a textual message printed on a paper strip. The present invention also relates to educational or recreational games, and to methods of instruction using “flash cards”.

It has long been known to insert paper strips bearing “fortunes”, predications, or messages of wisdom, in fortune cookies. These messages may inspire, or encourage new thinking, they are not, strictly speaking, educational. The cookies are generally hollow shapes containing the entirety of the fortune strip. Sometime, only a portion of the strip is contained within the cookie, and the remainder visible from the outside. More importantly, the cookie (with fortune) is not a food serving receptacle. However, the fortune strips are considered to add value to the cookies, and, perhaps, be the object of eating the cookie.

Messages may also be included in chocolates, such as shown in U.S. Design Pat. No. D444,613, wherein the messages are molded into the chocolates, though the chocolates are not receptacles for serving food. Brand indicating strips are folded into the wrapper of Hershey's Kisses®, but not molded into the chocolates. Tartufo, and chocolate dessert cups, are known, but chocolate is considered too fragile to form the containers of the present invention.

Ice cream cones have been known to carry brand advertisements, as shown in U.S. Pat. No. 4,859,476, which describes printing brand names onto ice cream cones with edible ink. U.S. Pat. No. 4,855,150 describes a rectangularly shaped paper band for an advertising message, fastened about the upper straight conical section of a traditional flat-bottomed wafer cone. The band is retained on the cone by an adhesive fastening to itself, and is long enough that one end makes a pull tab for easily removing the paper band.

Recreational toys have been included with food packages, such as cereal boxes and McDonald's® “Happy Meals”®. Conversely, “flash cards” or vocabulary cards, are generally presented in intimidating stacks, making them seem more like educational devices than toys, and evoking an atmosphere of school, and discipline. However, discipline is not the only environment for learning. People, and especially children, also learn in playful and pleasant environments.

### SUMMARY OF THE INVENTION

The present invention combines a strip carrying a message or other indicia with an edible, formed, food serving receptacle, such as an ice cream cone, to provide an interactive food container. In its most preferred embodiment the present invention comprises a cone or cornet having a paper strip embedded between the overlapping layers of a rolled dessert cone. The strip is removable from the receptacle, and may comprise a collectible piece, or a game piece.

According to the present invention, at least a portion of a strip carrying an indicia of value or significance is embedded in, but removable from, an edible, formed, food serving receptacle. The strip may contain a text message, such as a fortune, a health tip, or a puzzle clue. The present invention also includes a method of instruction, or play, using the removable indicia.

In one embodiment of the present invention, the strip has adhesive on the non-embedded portion, which may be covered by a releasable cover strip. The adhesive may provide a means for retaining the strip, after it has been removed from the receptacle, or cone.

Also included in the invention of the present application is a method of distributing sales coupons comprising embedding the sales coupon in the edible food serving receptacles of the present invention, and distributing the interactive containers formed thereby.

The present invention also provides a method of manufacturing the interactive food containers, in which a removable strip bearing an indicia, is embedded in the material of the receptacle as the receptacle is being formed.

It is an object of the present invention to provide an indicia strip embedded in an e.g. ice cream cone, for advertising, educating, and pleasure. The interactive container of the present invention offers a unique opportunity to instruct, using educational “tips” on strips removably attached to food serving receptacles, thereby attaching the information in the “tips” to the importance and pleasure of eating, and to the fun and enjoyment of eating an ice cream cone.

For a full understanding of the present invention, reference should now be made to the following detailed description of the preferred embodiments of the invention as illustrated in the accompanying drawings.

### BRIEF DESCRIPTION OF THE DRAWINGS

FIG. 1 is a schematic view, in perspective, of the dessert cone of the present invention.

FIG. 2 is a schematic view in perspective of a preferred strip according to the present invention.

### DETAILED DESCRIPTION OF THE INVENTION

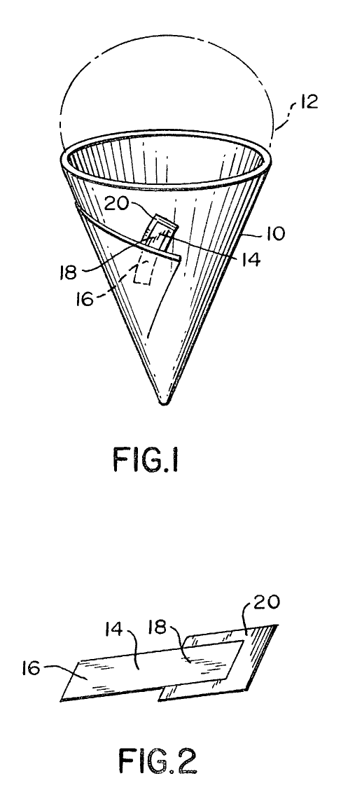

The preferred embodiments of the present invention will now be described with reference to FIGS. 1-2 of the drawings. Identical elements in the various figures are designated with the same reference numerals.

The present invention may be embodied in many different forms. This specification and accompanying drawings disclose only some specific forms as an example of the invention. However, the invention is not intended to be limited to the embodiments specifically described, and the scope of the invention will be pointed out in the appended claims.

The present invention comprises a combination of a cone, 10, or other serving receptacle for a food or dessert, 12, and a strip containing an indicia, such as a text message. In the preferred embodiment of the present invention, as seen in FIG. 1, the strip, 14, comprises a portion, 16, (unseen) embedded in the cone. The strip is sufficiently embedded that it will not fall out, but can be removed, as for example, by pulling on the non-embedded portion, 18, of the strip. If desired the strip can be sufficiently embedded in the cone that removal of the strip breaks the cone. The cone illustrated in FIG. 1 is generally made from sugar wafer material which is rolled into a cone shape after the sugar wafer material has been baked, and while the material is warm, so it will adhere to itself. This strip may be placed on the trailing edge of a piece of sugar wafer to be rolled into a cone, placing the strip with one portion, 16, embedded between the overlapping layers of the receptacle material, and a non-embedded portion, 18, that is visible on the outside of the cone. It should be noted that the food serving receptacles of the present invention may be made with sweeteners other than sugar.

The present invention is not intended to be limited to a dessert cone, but can be used in relation to cones made of other materials, and other cone shapes, such as the flat-bottomed dessert cone. In addition, the container of the present invention may be bowl shaped, may be sweet, or not sweet, for serving salad and any other foodstuff besides a dessert item. The receptacle may be formed from many edible, formable materials such as, but not exclusive to, a cookie, bread, biscuit, wafer, or meringue material. It is required that the formed receptacle not unwrap, but retain its shape for a time sufficient for serving and eating the food served therein. In addition, the container may be larger than single serving size, and contain sufficient servings for a table, with indicia appropriate for the group seated at the table.

A variety of foods may be served in the receptacle of the present invention such as, but not exclusive to, ice cream, sorbet, fruit or vegetables, pudding, jello or custard, hors dóeuvres, dips, candies or nuts, or in the case of a cornet, whipped cream.

The strip, 14, may be made of many different materials, such as paper or plastic, which can retain an indicia. In its preferred embodiment, the strip is made of printable paper. It may be edible, or made of a non-food material. For example, it may comprise a printed piece of paper or plastic, or an edible gel strip which may present a new flavor of candy or ice cream, or may contain vitamins, or other nutritional aid, or medication. It is important that the strip be removable, and bear an indicia of significance.

While it is well-known that desserts such as fortune cookies contain a paper strip upon which is printed a textual message of good fortune, advice or wisdom, these fortune “strips” do not relate to the cookie itself. According to the present invention the removable strip may contain textual subject matter, such as the listed ingredients of the dessert served in the cone, nutritional information relating to the dessert, or more general health and nutrition tips such as the number of minutes of exercise needed to “burn” the serving of the dessert portion. In one specific instance, the strips may be used to teach nutrition broadly to users of all ages, for their general health education, and to provide a nutritional context for the sweets or other food served in the formed receptacle. In addition, “kiddie” cones may be made available, not only for children, but to teach portion size to adults.

The indicia of the removable strip may apply to many play and learning circumstances, unrelated to e.g. dessert. For instance, the indicia or picture on the removable strip may be a collectible; a picture, or piece, which is one of a known, desired set. Alternatively, the strip may comprise a game piece, or puzzle piece, or may contain a question on one side, and the answer on the other side. In addition, and especially as relates to dessert receptacles for children, the removable strip may bear simply a picture or design, or a message depicted in pictures. When the strip serves one of these functions, it may be provided with a means by which to save it, or attach it to a game board. One such means is shown in FIG. 2, in which the strip, 14, is provided with an adhesive layer on the under side of the strip, which in turn is provided with a cover strip, 20. The cover strip provides a barrier to accidentally getting the adhesive in the dessert, and maintains the adhesive until use. The cover strip, 20, may also be used to conceal the indicia until after purchase. However, when it is desired to hide the indicia, it may be easier to place the indicia on the embedded portion of the strip, which is also covered by the present invention.

Alternatively, the removable strip may be a sales or marketing device, such as a coupon for a free cone serving upon the purchase of a preset number of servings, or a discount coupon on future sales of desserts, or any other item, such as, but not exclusive to toys, books, clothing, or amusement ride. At its simplest, it may comprise only a color, with the color of successive strips varied, providing the basis for, but not exclusive to, a story, game or contest.

There has thus been shown and described a novel dessert cone with embedded strip which fulfills all the objects and advantages sought therefore. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. An interactive container for a food, comprising an edible formed serving receptacle, and a strip having a portion thereof embedded in the formed receptacle, but removable therefrom, said strip bearing an indicia.

2. The interactive container for a food of claim 1, wherein the receptacle comprises a rolled dessert cone, and at least a portion of the indicia strip is embedded between two overlapping layers of the cone.

3. The interactive container for a food of claim 2, wherein the strip further comprises a partial layer of adhesive on the non-embedded portion, said adhesive being covered by a releasable cover strip.

4. The interactive container for a food of claim 2, wherein the indicia is a textual message.

5. The interactive container for a food of claim 4, wherein the textual message relates to the food served in the receptacle.

6. The interactive container for a food of claim 1, wherein the strip is a sales promotional coupon.

7. The interactive container for a food of claim 4, wherein the textual message is a nutritional plan complementing the food served in the receptacle.

8. The interactive container for a food of claim 1, wherein the strip bears a pictorial message about a nutritional plan which complements the food served in the receptacle.

9. The interactive container for a food of claim 1, wherein the strip with indicia is one of a collectible set.

10. A collection of interactive containers for a food as in claim 1, wherein indicia for each of the containers in the collection relate to a common theme, game or puzzle.

11. In combination, an edible serving receptacle for a food, comprising a formed receptacle, and a strip bearing an indicia, said strip embedded in the formed receptacle, but removable therefrom.

12. The combination of claim 11, wherein the receptacle comprises a dessert cone, formed by rolling.

13. The combination of claim 12, wherein the indicia born on the strip is a textual message.

14. The combination of claim 11, wherein the strip is a sales coupon.

15. A method of instruction comprising providing an interactive container for food, said container comprising an edible, formed receptacle for at least one food serving, and an instructional indicia on a strip, a portion of which is embedded in the formed receptacle.

16. The method of claim 15, wherein the indicia is a health tip.

17. The method of claim 16, wherein the indicia relates to nutrition.

18. The method of claim 17, wherein the indicia relates to the nutritional value of the food served in the receptacle.

19. A method for manufacturing an interactive container for food, comprising an edible formed receptacle and an indicia of importance, said method comprising, providing an edible material for forming an edible serving receptacle, providing a strip bearing an indicia, attaching at least a portion of the strip to the edible material, and forming the edible serving receptacle.

20. The method of claim 19, wherein the formed, food serving receptacle is a dessert cone, and the strip is attached to the trailing edge of the cone material before rolling the cone.

21. A method of distributing sales coupons comprising embedding the sales coupon in and edible food serving receptacle, and distributing the receptacles.

22. The method of claim 21, wherein the receptacle is a dessert cone.

23. Method of providing food portion required with a medication, comprising, providing the combination of claim 11, wherein the indicia comprises a medication, and the receptacle is pre-filled with a food of the type required to be taken with the medication.
